(19) United States
(12) Patent Application Publication
(10) Pub. No.: US 2025/0067379 A1
(43) Pub. Date: Feb. 27, 2025

(54) FLUID LINE SYSTEM

(71) Applicant: Endress+Hauser Flowtec AG, Reinach (CH)

(72) Inventors: Benjamin Schwenter, Ettingen (CH); Severin Ramseyer, Münchenstein (CH); Christian Schütze, Basel (CH); Marc Werner, Grenzach-Wyhlen (DE)

(21) Appl. No.: 18/725,955

(22) PCT Filed: Dec. 12, 2022
(86) PCT No.: PCT/EP2022/085421

§ 371 Date: Jul. 1, 2024

(30) Foreign Application Priority Data
Jan. 5, 2022 (DE) 10 2022 100 227.6

(51) Int. Cl. F16L 41/00; G01F 15/18; G01K 13/02; G01N 9/24; G01N 11/00

(52) U.S. Cl. CPC F16L 41/008; G01F 15/185; G01K 13/02; G01N 9/24; G01N 2011/0073

(57) ABSTRACT

A fluid line system includes a fitting having a lumen extending from first and second flow openings to a third flow opening located in a remote fitting end; first and second fluid lines, each having a lumen; and a flow-conditioner element inserted into the lumen of the fitting and non-detachably connected thereto and has first and second flow channels connected fluidically in parallel. Each of the two flow channels of the flow-conditioner element extends from a first flow opening located in a region of its element end to a second flow opening located in a region of its opposite element end, and the flow-conditioner element is positioned and oriented in the fitting such that a first flow path includes both the first flow channel and the first fluid line, and a second flow path includes both the second flow channel and the second fluid line.

The invention relates to a fluid line system formed by means of at least one (connecting) fitting and by means of at least two fluid lines connected thereto.

Such fluid line systems as well as their use in a measuring transducer serving to measure at least one measurement variable of a fluid measurement substance carried in a pipeline or a measuring device formed therewith, such as a Coriolis mass flow meter, are described, inter alia, in US-A 2009/0266177, US-A 2015/0082916, US-A 2018/0313487, US-A 2019/0376831, US-A 2020/0049543, US-A 48 01 897, US-B 10 9218, U.S. Pat. No. 10,809,109, US-B10 705 055, WO-A 2006/091199, WO-A 2006/107297, WO-A 2008/024112, WO-A 2015/162617, WO-A 2017/048235, WO-A 2017/105493, WO-A 2019/017891, WO-A 2020/023056, or the (not pre-published) international application PCT/EP2020/081924.

Each of the aforementioned fluid line systems comprises a (connecting) fitting—here serving as a line branch or as a line union—as well as two fluid lines—for example, each designed as a rigid and/or at least partially circular-cylindrical pipe.

The (connecting) fitting-occasionally also referred to as a distributor, collector, or Y-piece, or also as a flow divider—has a (fitting) wall and a lumen, which is enclosed by said wall and extends from mutually spaced-apart first and second flow openings located in a first fitting end of the (connecting) fitting as far as a third flow opening, which is located in a second fitting end of said (connecting) fitting located remotely from the first fitting end and is typically enclosed by a (standard) connecting flange and/or is circular, and each of the fluid lines has a (line) wall and also a lumen, which is enclosed by the (line) wall and extends from a first flow opening located in a first line end as far as a second flow opening located in a second line end of said fluid line. The wall of the (connecting) fitting has, in the region of the first fitting end, a front-side first (fitting) inner surface (facing the lumen of the first fitting), within which the aforementioned first and second flow openings (of the fitting) are formed, as well as a lateral second (fitting) inner surface (facing the lumen of the first fitting) extending from the first fitting end as far as the second fitting end and adjacent to the first inner surface, or forms the aforementioned first and second (fitting) inner surfaces. The wall of the (connecting) fitting as well as the wall of each of the fluid lines can, for example, consist of a metal, such as stainless steel. The first and second flow openings can each be circular or, as shown for example in WO-A 2017/048235 or WO-A 2017/198440, oval-shaped or, as shown for example in WO-A 2017/105493, circular-segment-shaped.

In order to form (first and second) flow paths of the fluid line system involving the lumen of the (connecting) fitting and the lumen of the first and second fluid lines, each of the fluid lines is connected with its respective first line end to the first line end of the (connecting) fitting, such that the first flow opening of the first fluid line opens into the first flow opening of the (connecting) fitting, and the first flow opening of the second fluid line opens into the second flow opening of the (connecting) fitting, and such that the aforementioned lumens of the fluid line and the fitting communicate with each other. Accordingly, such a fluid line system can be used, among other things, in such a way that its (connecting) fitting serves as a line union, for example—as also shown in US-A 2017/0219398, US-A 2018/0313487, US-A 2019/0376831, US-A 2020/0049543, or WO-A 2008/024112-to (re) combine or mix separate fluid flows, viz., those guided through the first fluid line or the second fluid line to the (connecting) fitting, possibly also independently of one another and/or with different compositions, by means of the (connecting) fitting.

The fluid line systems of the type in question, as already mentioned, or shown in the aforementioned US-A 2009/0266177, US-A 2015/0082916, US-A 2018/0313487, US-A 2019/0277683, US-A 2019/0376831, US-A 2020/0049543, US-A 48 01 897, US-B 10 9218, U.S. Pat. No. 10,809,109, US-B10 705 055, WO-A 2006/091199, WO-A 2006/107297, WO-A 2008/024112, WO-A 2015/162617, WO-A 2017/048235, WO-A 2017/105493, WO-A 2019/017891, WO-A 2020/023056, or PCT/EP2020/081924, can also be designed in each case as an integral component of a measuring transducer, e.g., a vibronic measuring transducer, which is used or is set up to generate at least one measurement signal corresponding to at least one measurement variable—for example, a mass flow (mass flow rate), a density, or a viscosity-of the fluid flowing through, viz., at least one signal parameter dependent upon said measurement variable—for example, a signal level dependent upon said measurement variable and/or a signal frequency dependent upon said measurement variable and/or a phase angle dependent upon said measurement variable. The measuring transducer can in turn be connected to corresponding measuring and operating electronics to form a (vibronic) measuring device—for example, a Coriolis mass flow meter, a vibronic density meter, and/or a vibronic viscosity meter. Accordingly, the first and second fluid lines can in particular also be designed to be passed through by the fluid to be measured and to be vibrated during this time in order to generate the at least one measurement signal, wherein the measurement signal typically serves as at least one vibration measurement signal representing vibration movements of the first and/or second fluid lines with at least one signal frequency dependent upon a density of the fluid conducted in the fluid lines and/or a phase angle dependent upon a mass flow rate. In order to excite or maintain mechanical vibrations of the fluid lines, for example, viz., opposing bending vibrations of the first and second fluid lines, each of the aforementioned fluid line systems or the measuring transducer formed thereby further comprises at least one electromechanical, e.g., electrodynamic, vibration exciter. In addition, such a fluid line system or the measuring transducer formed thereby has at least one vibration sensor, e.g., attached at least to the first fluid line and/or at least placed in its vicinity, for generating the at least one measuring signal corresponding to the measurement variable. Not least for the aforementioned case where the measuring transducer or the measuring device formed therewith is intended to measure a mass flow or a mass flow rate of the fluid flowing through it, such a fluid line system can also comprise at least two vibration sensors which are attached to the first and/or second fluid line at a distance from one another and/or at least placed in their vicinity, possibly also of identical construction, which are each set up to generate a measuring signal corresponding to the measurement variable, in particular in such a way that a phase difference dependent upon the mass flow rate is established between the two measuring signals. For the purpose of determining the measurement variable, the two fluid lines are typically actively excited by such vibronic measuring transducers to produce opposing bending vibrations in a drive or useful mode, viz., to produce vibrations at at least one vibration frequency serving as a useful frequency for the measurement, e.g., at one or more instantaneous resonance frequencies of natural vibration modes inherent in the fluid line system and/or—as shown, for example, in US-A 48 01 897 mentioned at the outset-by means of an electronic driver circuit provided in the measuring device electronics, electrically coupled to the at least one vibration exciter and the at least one vibration sensor and possibly designed as a phase locked loop (PLL). Such fluid line systems or vibronic measuring transducers formed therewith, e.g., those used to generate Coriolis forces dependent upon a mass flow of the flowing fluid, are also manufactured by the applicant themself or in conjunction with suitably configured measuring electronics as Coriolis mass flow meters or as Coriolis mass flow/density meters—for example, under the product names “PROMASS F 200,” “PROMASS G 100,” “PROMASS O 100,” “PROMASS 83E,” “PROMASS 84F,” “CNGmass,” “LPGmass,” or “Dosimass.”

Not least in the aforementioned case where the fluid line system is part of a measuring transducer used to measure fluid media conveyed in a pipeline, the fluid line system can also have a further (second) (connecting) fitting—for example, of an identical construction to the aforementioned (first) (connecting) fitting. Said second (connecting) fitting is-analogously to the first (connecting) fitting-connected with its first line end both to the second line end of the first fluid line, which is remote from the first line end connected to the first (connecting) fitting, and to the second line end of the second fluid line, which is remote from the first line end of the first line end likewise connected to the first (connecting) fitting, such that both the lumen of the first fluid line and the lumen of the second fluid line communicate with both the lumen of the first (connecting) fitting and the lumen of the second (connecting) fitting, or that the second flow opening of the second fluid line opens into the first flow opening of the second (connecting) fitting, and the second flow opening of the second fluid line opens into the second flow opening of the second (connecting) fitting, so that as a result the aforementioned first and second flow paths are connected fluidically in parallel. In addition, the fluid line system can be designed or configured to be inserted into the course of a pipeline in such a way that a fluid flow fed to the fluid line system or the measuring transducer formed thereby is divided into two separate fluid flows by means of one of the two (connecting) fittings, thus within the fluid line system or measuring transducer, and that the same fluid flows are recombined into a single fluid flow by means of the other of the (connecting) fittings, thus also within the fluid line system, so that the fluid line system acts as a single pipe fluidically or to the outside and can also be connected to the corresponding segments of the pipeline very easily and without any further technical effort by means of (standard) flange connections.

Fluid line systems of the type in question, as is also readily apparent from a consideration in combination of the above-mentioned US-A 2009/0266177, US-A 2015/0082916, US-A 2018/0313487, US-A 2019/0376831, US-A 2020/0049543, US-A 48 01 897, US-B 10 42 9218, U.S. Pat. Nos. 10,809,109, 10,705,055, WO-A 2006/091199, WO-A 2006/107297, WO-A 2008/024112, WO-A 2015/162617, WO-A 2017/048235, WO-A 2017/105493, WO-A 2019/017891, WO-A 2020/023056, and PCT/EP2020/081924, can have (connecting) fittings specifically adapted to a high degree to the respective pipe shapes and/or operating conditions, possibly also to the respective measuring tasks, in such a way that, for the purpose of suitable conditioning of the fluid flowing into the fluid line system or out of the fluid line system, the respective first (fitting) inner surface is not planar and/or the respective second (fitting) inner surface is not (circular-) cylindrical, and consequently the respective lumen thereof has a (complex) shape overall which differs considerably from a simple circular cylinder, e.g., in order to avoid undesirable disturbances, e.g., in the form of a high pressure loss and/or in the form of noise and/or in the form of vortices, etc., being caused by the fluid line system within the measurement substance flowing through the fluid line system, or to minimize such disturbances.

Accordingly, the variety of variants of fittings to be used for the production of such a fluid line system can be high on the one hand, and, on the other, the respective production of such a fitting, specifically “tailored” for the desired flow conditioning, can be technically very complex. As a result, the overall manufacturing costs of fluid line systems of the type in question can be correspondingly high.

Based upon the aforementioned prior art, one object of the invention is to improve fluid line systems of the type in question in such a way that a respective fluid line system or its influence on the fluid flowing through it during operation can be adapted to the respective operating conditions or to the respective measuring task in a simple manner and with low manufacturing costs.

To achieve the object, the invention consists in a fluid line system, e.g., for a measuring transducer used to measure at least one measurement variable of a fluid medium guided in a pipeline or a measuring device formed therewith, which fluid line system comprises:
a first (connecting) fitting, designed for example as a line branch or as a line union, with a lumen which is surrounded by a wall, e.g., made of a metal, and extends from first and second, e.g., spaced apart from one another and/or circular, flow openings located in a first fitting end of the first (connecting) fitting, as far as a third flow opening, which is for example circular, located in a second fitting end of said first (connecting) fitting, e.g., enclosed by a connecting flange and remote from the first fitting end,
a first fluid line, e.g., formed as a rigid and/or at least partially circular-cylindrical tube, comprising a lumen that is enclosed by a wall, e.g., made of metal, and extends from a first flow opening, which is for example circular and which is located in a first line end of the first fluid line, as far as a second flow opening, which is for example circular and which is located in a second line end of said first fluid line,
at least one second fluid line, which is formed for example as a rigid and/or at least partially circular-cylindrical tube and/or structurally identical to the first fluid line, having a lumen, which is enclosed by a wall made, for example, out of metal, and extends from a first flow opening, which is for example circular and which is located in a first line end of the second fluid line, as far as a second flow opening, which is for example circular and which is located in a second line end of said second fluid line,
and a (first) flow-conditioner element, e.g., monolithic and/or cylindrical and/or metallic, which is inserted into the lumen of the first (connecting) fitting and is non-detachably connected thereto, for example, and/or through the third flow opening of the first (connecting) fitting and/or without a gap, with first and second, e.g., non-circular-cylindrical and/or non-truncated-cone-shaped, flow channels connected fluidically in parallel, of which flow-conditioner element a first (flow-conditioner) element end faces the first fitting end of the first (connecting) fitting, and a second (flow-conditioner) element end remote from the first (flow-conditioner) element end faces the second fitting end of the first (connecting) fitting.

Each of the first and second flow channels extends from a respective first flow opening, which for example is circular and which is located in the region of the first (flow-conditioner) element end, as far as a respective second flow opening, which for example is non-circular and which is located in the region of the second (flow-conditioner) element end.

In addition, the first fluid line is connected with its first line end to the first line end of the first (connecting) fitting in such a way that the first flow opening of the first fluid line opens into the first flow opening of the first (connecting) fitting located in the first fitting end of the first (connecting) fitting, and the second fluid line is connected with its first line end to the first line end of the first (connecting) fitting in such a way that the first flow opening of the second fluid line opens into the second flow opening of the first (connecting) fitting located in the first fitting end of the first (connecting) fitting.

In the fluid line system according to the invention, the flow-conditioner element is also positioned and aligned in the first (connecting) fitting such that a first flow path (of the fluid line system) (extending partially through the first fitting) involving the first flow channel of the flow-conditioner element and the lumen of the first fluid line and a second flow path (of the fluid line system) (extending partially through the first fitting) involving the second flow channel of the flow-conditioner element and the lumen of the second fluid line are formed.

Furthermore, the invention also consists in a measuring device, e.g., also vibronic, formed by means of a fluid line system, for detecting at least one measurement variable of a flowing medium and for generating at least one measurement signal corresponding to the at least one measurement variable, or also in a measuring device formed with the measuring transducer and measuring device electronics electrically connected to it, which serve to process the at least one measurement signal.

Furthermore, the invention also consists of using such a device for determining measured values for at least one measurement variable—for example, specifically of a mass flow rate, a mass flow, a volumetric flow rate, a volumetric flow, a density, a viscosity, or a temperature-of a fluid measurement substance guided in a pipe, e.g., a gas, a liquid, or a dispersion—for example, also such that the first (connecting) fitting is arranged on the inlet side with respect to a flow direction of the measurement substance which flows through the measuring transducer and/or that the measurement substance is allowed to flow in a predetermined flow direction through the pipe and the measuring transducer incorporated into said pipe.

According to a first embodiment of the invention, it is further provided that the first flow opening of the first flow channel (of the flow-conditioner element) be circular.

According to a second embodiment of the invention, it is further provided that the second flow opening of the first flow channel (of the flow-conditioner element) have a (cross-sectional) shape that differs from a (cross-sectional) shape of the first flow opening of the first flow channel (of the flow-conditioner element).

According to a third embodiment of the invention, it is further provided that the second flow opening of the first flow channel (of the flow-conditioner element) not be circular—for example, viz., circular-segment-shaped.

According to a fourth embodiment of the invention, it is further provided that the first flow opening of the first flow channel (of the flow-conditioner element) have a (cross-sectional) shape corresponding to a (cross-sectional) shape of the first flow opening of the (connecting) fitting (100).

According to a fifth embodiment of the invention, it is further provided that the first flow opening of the second flow channel (of the flow-conditioner element) be circular.

According to a sixth embodiment of the invention, it is further provided that the second flow opening of the second flow channel (of the flow-conditioner element) have a (cross-sectional) shape that differs from a (cross-sectional) shape of the first flow opening of the second flow channel (of the flow-conditioner element).

According to a seventh embodiment of the invention, it is further provided that the second flow opening of the second flow channel (of the flow-conditioner element) not be circular—for example, viz., circular-segment-shaped.

According to an eighth embodiment of the invention, it is further provided that the first flow opening of the second flow channel (of the flow-conditioner element) have a (cross-sectional) shape corresponding to a (cross-sectional) shape of the second flow opening of the (connecting) fitting.

According to a ninth embodiment of the invention, it is further provided that the first flow channel (of the flow-conditioner element) have a shape which is identical to a shape of the second flow channel (of the flow-conditioner element).

According to a tenth embodiment of the invention, it is further provided that the flow-conditioner element be disc-shaped.

According to an eleventh embodiment of the invention, it is further provided that the flow-conditioner element be at least partially (circular-) cylindrical.

According to a twelfth embodiment of the invention, it is further provided that the flow-conditioner element consist at least partially of a metal.

According to a thirteenth embodiment of the invention, it is further provided that the flow-conditioner element consist at least partially of a plastic.

According to a fourteenth embodiment of the invention, it is further provided that the flow-conditioner element consist at least partially of a ceramic.

According to a fifteenth embodiment of the invention, it is further provided that the flow-conditioner element be at least partially manufactured by a, for example, generative or additive (3-D printing) primary forming process—for example, a solid free-form fabrication and/or a powder bed process.

According to a sixteenth embodiment of the invention, it is further provided that the wall of the fitting consist at least partially of a rust-free steel—for example, a stainless steel, a duplex steel, or a super duplex steel.

According to a seventeenth embodiment of the invention it is further provided that the wall of the fitting be made of a nickel-molybdenum alloy—for example, a nickel-molybdenum-chromium alloy, AISI 304, AISI 304L, AISI 316L, WNo. 1.4401, WNo. 1.4404, UNS S31603, WNo. 1.4410, WNo. 14501, Hastelloy B, or Hastelloy C—for example, Hastelloy C-22.

According to an eighteenth embodiment of the invention it is further provided that the wall of the first fluid line (100) be made of a nickel-molybdenum alloy—for example, a nickel-molybdenum-chromium alloy, AISI 304, AISI 304L, AISI 316L, WNo. 1.4401, WNo. 1.4404, UNS S31603, WNo. 1.4410, WNo. 14501, Hastelloy B, or Hastelloy C—for example, Hastelloy C-22.

According to a nineteenth embodiment of the invention it is further provided that the wall of the second fluid line (200) be made of a nickel-molybdenum alloy—for example, a nickel-molybdenum-chromium alloy, AISI 304, AISI 304L, AISI 316L, WNo. 1.4401, WNo. 1.4404, UNS S31603, WNo. 1.4410, WNo. 14501, Hastelloy B, or Hastelloy C—for example, Hastelloy C-22.

According to a twentieth embodiment of the invention, it is further provided that the wall of the first fluid line consist of the same material as the wall of the second fluid line.

According to a twenty-first embodiment of the invention, it is further provided that the wall of the first fluid line consist of the same material as the wall of the fitting.

According to a twenty-second embodiment of the invention, it is further provided that the wall of the second fluid line consist of the same material as the wall of the fitting.

According to a twenty-third embodiment of the invention, it is further provided that the first fluid line, at least in sections, be curved, in particular V-shaped and/or U-shaped and/or circular-arc-shaped.

According to a twenty-fourth embodiment of the invention, it is further provided that the first fluid line be straight at least in sections—for example, specifically, hollow-cylindrical.

According to a twenty-fifth embodiment of the invention, it is further provided that the wall of the first (connecting) fitting form or have a front-side (facing the lumen of the first fitting), first (fitting) inner surface, which is located in the region of the first fitting end of said first (connecting) fitting and for example is at least partially planar and/or circular, within which the first and second flow openings (of the first fitting) are also located, as well as a lateral second (fitting) inner surface (facing the lumen of the first fitting), which extends from the first fitting end as far as the second fitting end, adjacent to the first (fitting) inner surface, and for example is at least partially (circular-) cylindrical. Developing this embodiment of the invention, it is further provided that the flow-conditioner element have a front-side first outer surface forming the first (flow-conditioner) element end or facing the first fitting end, e.g., at least partially planar and/or circular, and/or contacting the first (fitting) inner surface of the first (connecting) fitting and/or at least partially complementary to the first (fitting) inner surface of the first (connecting) fitting, as well as a lateral second outer surface (shell surface) facing the lateral second (fitting) inner surface of the wall of the first (connecting) fitting, e.g., contacting the second (fitting) inner surface of the first (connecting) fitting and/or at least partially complementary to the second inner surface of the first (connecting) fitting and/or at least partially (circular-) cylindrical. Furthermore, the flow-conditioner element has a front-side third (connecting) outer surface facing the second fitting end of the first (connecting) fitting, e.g., at least partially curved and/or (circular-) ring-shaped in a region, adjacent to the wall, of the first (connecting) fitting, in particular such that the third outer surface forms a (first) bifurcation (of the fluid line system) connecting the first and second flow paths.

According to a twenty-sixth embodiment of the invention, it is further provided that the flow-conditioner element be non-detachably connected to the first (connecting) fitting by being welded and/or soldered and/or expanded into the first (connecting) fitting.

According to a twenty-seventh embodiment of the invention, it is further provided that the flow-conditioner element be non-detachably connected to the first (connecting) fitting by gluing and/or pressing and/or caulking the flow-conditioner element and the first (connecting) fitting together.

According to a twenty-eighth embodiment of the invention, it is further provided that the flow-conditioner element be non-detachably connected to the first (connecting) fitting by shrinking the first (connecting) fitting onto the flow-conditioner element.

According to a first embodiment of the measuring transducer of the invention, the first and second fluid lines are arranged to be flowed through by the measurement substance and to be allowed to vibrate during this process.

According to a second embodiment of the measuring transducer of the invention, the measuring transducer is configured to be integrated into a piping system, e.g., in such a way that the second fitting end of the first (connecting) fitting is connected to a pipe end, facing the measuring transducer, of a first pipe segment of the piping system and/or that the second fitting end of the second (connecting) fitting is fluidically connected to a pipe end, facing the measuring transducer, of a second pipe segment of the piping system—for example, to form a fluid duct that extends from the first pipe segment as far as the second pipe segment and/or is leakage-free.

According to one embodiment of the measuring device of the invention, the measuring device electronics are designed to feed an electrical driver signal into the measuring transducer and/or to process one or more measuring signals generated by means of the measuring transducer.

According to a first development of the invention, the fluid line system further comprises sealing means positioned within the lumen of the first (connecting) fitting, viz., at least partially between the second inner surface (of the wall of the first fitting) and the second outer surface (of the flow-conditioner element)—for example, formed by means of at least one annular sealing element. The sealing means may, for example, comprise an O-ring placed on the flow-conditioner element and/or a shaft sealing ring placed on the flow-conditioner element.

According to a second development of the invention, the fluid line system further comprises a second (connecting) fitting, e.g., designed as a line branch or as a line union and/or identical in construction to the first (connecting) fitting, with a lumen which is surrounded by a wall, e.g., made of a metal, and extends from first and second flow openings, which for example are spaced apart from one another and/or are circular, and which are located in a first fitting end of the second (connecting) fitting as far as a third flow opening, which for example is circular and which is located in a second fitting end of said second (connecting) fitting, e.g., held by a connecting flange and remote from the first fitting end, wherein the first fluid line is connected with its second line end to the first line end of the second (connecting) fitting in such a way that the second flow opening of the first fluid line opens into the first flow opening of the second (connecting) fitting, and wherein the second fluid line is connected with its second line end to the first line end of the second (connecting) fitting, such that the second flow opening of the second fluid line opens into the second flow opening of the second (connecting) fitting located in the first fitting end of the second (connecting) fitting. Furthermore, the fluid line system comprises a second flow-conditioner element inserted into the lumen of the second (connecting) fitting, e.g., releasably and/or through the third flow opening of the second (connecting) fitting and/or without a gap, e.g., locked thereon in a manner secured against rotation at least with respect to an (imaginary) longitudinal axis of the second (connecting) fitting and/or immovably along the same longitudinal axis and/or monolithic and/or cylindrical and/or metallic, with first and second flow channels connected fluidically in parallel, which for example are non-circular-cylindrical and/or are non-truncated-cone-shaped, of which second flow-conditioner element a first (flow-conditioner) element end faces the first fitting end of the second (connecting) fitting, and a second (flow-conditioner) element end remote from the first (flow-conditioner) element end faces the second fitting end of the second (connecting) fitting, wherein each first and second flow channels of the second flow-conditioner element in each case extend from a respective first flow opening, which for example is circular and which is located in the first (flow-conditioner) element end, as far as a respective second, e.g., non-circular, flow opening located in the second (flow-conditioner) element end, and wherein the second flow-conditioner element is positioned and aligned in the second (connecting) fitting such that the first flow path (of the fluid line system) involves the first flow channel of the second flow-conditioner element, and the second flow path (of the fluid line system) involves the second flow channel of the second flow-conditioner element. The wall of the second (connecting) fitting can have a front-side first (fitting) inner surface located in the region of its first fitting end, e.g., at least partially planar and/or circular, and a lateral second (fitting) inner surface facing the lumen (of the second fitting), extending from the first fitting end as far as the second fitting end, adjacent to the first (fitting) inner surface, e.g., at least partially (circular-) cylindrical—for example, such that the first and second flow openings (of the second fitting) are located within the first (fitting) inner surface (of the wall of the second fitting). In addition, the second flow-conditioner element can have a front-side first outer surface forming the first (flow-conditioner) element end or facing the first fitting end of the second (connecting) fitting, e.g., at least partially planar and/or circular, and/or contacting the first inner surface of the second (connecting) fitting and/or at least partially complementary to the first (fitting) inner surface of the second (connecting) fitting, a lateral second outer surface (shell surface) facing the lateral second (fitting) inner surface of the wall of the second (connecting) fitting, e.g., contacting the second inner surface of the second (connecting) fitting and/or at least partially complementary to the second inner surface of the second (connecting) fitting and/or at least partially (circular-) cylindrical, and a lateral second outer surface (shell surface) facing the second fitting end of the second (connecting) fitting, e.g., at least partially curved and/or in a region of the second (connecting) fitting have a (circular-) ring-shaped, front-side third outer surface; this, for example, also in such a way that the second flow-conditioner element has a design that deviates from a design of the first flow-conditioner element—for example, in that at least the third outer surface of the second flow-conditioner element has a (spatial) form that deviates from a (spatial) form of the third outer surface of the first flow-conditioner element.

According to a first development of the measuring transducer of the invention, it further comprises a (transducer) protective housing, wherein the (transducer) protective housing has a cavity surrounded by a wall, e.g., made of a metal, within which the first and second fluid lines are placed, and wherein a first housing end of the protective housing is formed by means of the first (connecting) fitting, and a second housing end of the (transducer) protective housing is formed by means of the second (connecting) fitting, such that the protective housing has a side wall which at least partially delimits the cavity laterally and which is fixed laterally both to the first (connecting) fitting, e.g., viz., its first fitting end, and to the second (connecting) fitting, e.g., viz., its first fitting end, or is connected thereto in an integrally bonded manner.

According to a second development of the measuring transducer of the invention, it further comprises an electro-mechanical excitation arrangement which is designed to convert electrical power into mechanical power causing mechanical (useful) vibrations of the first and second fluid lines.

According to a third development of the measuring transducer of the invention, it further comprises a sensor arrangement which is designed to detect mechanical vibrations of the first and second fluid lines and to provide at least one vibration signal, e.g., electrical, representing vibrations of at least one of the first and second fluid lines—for example, viz., at least two vibration signals.

According to a first development of the measuring device of the invention, the measuring transducer further comprises an electro-mechanical excitation arrangement which is designed to convert electrical power into mechanical power causing mechanical (useful) vibrations of the first and second fluid lines. For example, the excitation arrangement can be further configured to convert electrical power fed by the measuring device electronics, e.g., by means of an electrical driver signal, into mechanical power causing mechanical vibrations of at least the first fluid line—for example, of both the first fluid line and a second fluid line. Accordingly, according to a further embodiment of the invention, the measuring device electronics are electrically coupled to the excitation arrangement—for example, in order to feed electrical power into the excitation arrangement by means of an electrical driver signal.

According to a second development of the measuring device of the invention, the measuring transducer further comprises a sensor arrangement which is designed to detect mechanical vibrations of the first and second fluid lines and to provide at least one vibration signal, e.g., electrical, representing vibrations of at least one of the first and second fluid lines—for example, viz., at least two vibration signals. Furthermore, the measuring device electronics can be electrically coupled to the first sensor arrangement and therefore configured to process the at least one vibration signal—for example, specifically to determine measured values for the at least one measurement variable by means of the at least one vibration signal.

A basic idea of the invention is to technically simplify the manufacture of fluid line systems of the type in question or to enable a more cost-effective manufacture of fluid line systems that are individually adapted to specific application conditions compared to conventional fluid line systems by providing the components that serve to influence or condition the flow and are usually very complex to manufacture, in the form of a much more cost-effective prefabricated flow conditioning element, which (initially separate) flow conditioning element is inserted into a corresponding (connecting) fitting with a lumen that is as uniform as possible, e.g., circular-cylindrical, and is thus connected non-detachably, in particular so as not to be releasable or removable without deformation, damage, or destruction of the flow conditioning element and/or the (connecting) fitting.

The invention as well as advantageous embodiments thereof are explained in more detail below based upon exemplary embodiments shown in the figures of the drawings. Identical or identically acting or identically functioning parts are provided with the same reference signs in all figures; for reasons of clarity or if it appears sensible for other reasons, reference signs mentioned before are dispensed with in subsequent figures. Further advantageous embodiments or developments, especially, combinations of partial aspects of the invention that were initially explained only separately, furthermore emerge from the figures of the drawing and/or from the claims themselves.

In the figures, in detail:

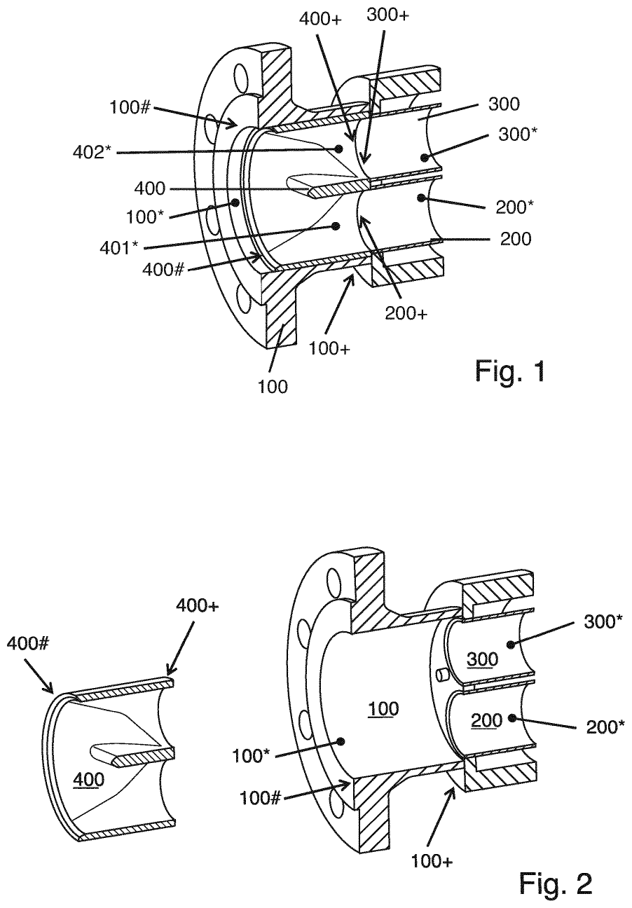

FIG. 1 shows a fluid line system according to the invention in a sectional (side) view;

FIG. 2 shows a sectional (exploded) view of the fluid line system according to FIG. 1 partially disassembled into individual parts;

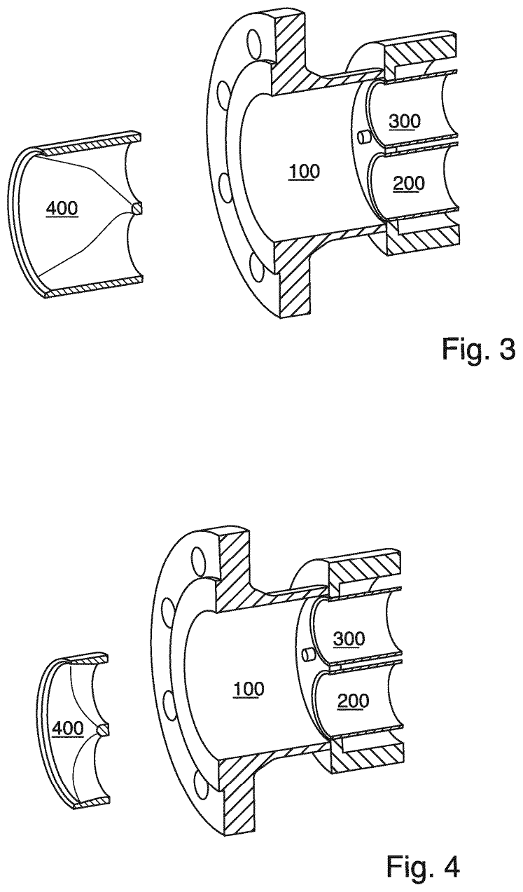

FIGS. 3, 4 each show a further variant of a fluid line system according to the invention in a sectional (exploded) view;

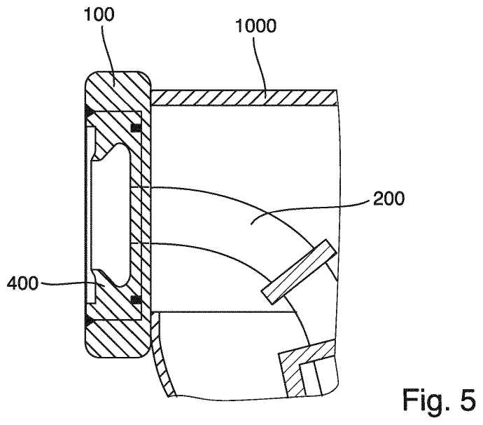

FIG. 5 shows a schematic sectional side view of another exemplary embodiment of a fluid line system according to the invention;

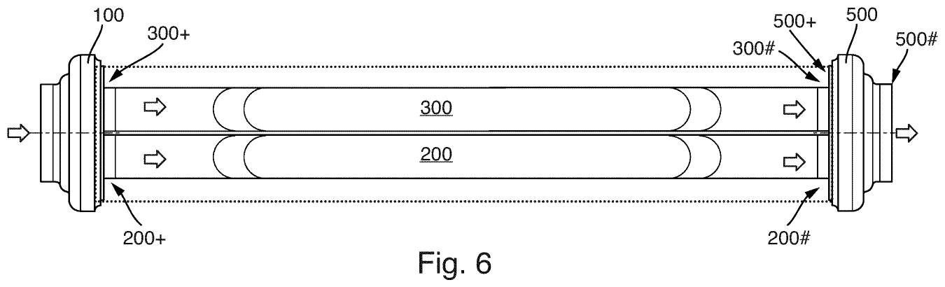

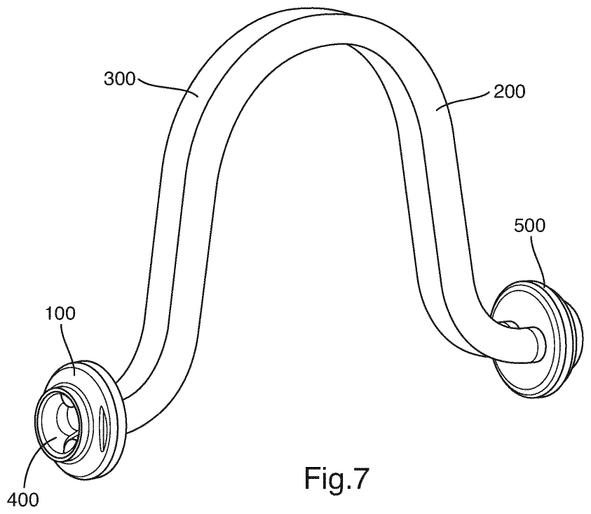

FIG. 6 shows a perspectival side view of a further exemplary embodiment of a fluid line system according to the invention;

FIG. 7 shows a schematic perspectival second side view of a fluid line system according to FIG. 6;

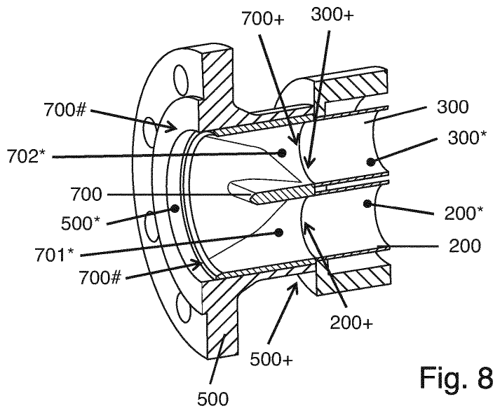

FIG. 8 shows a sectional (side) view of a partial region of a fluid line system according to FIG. 6 or 7; and 8

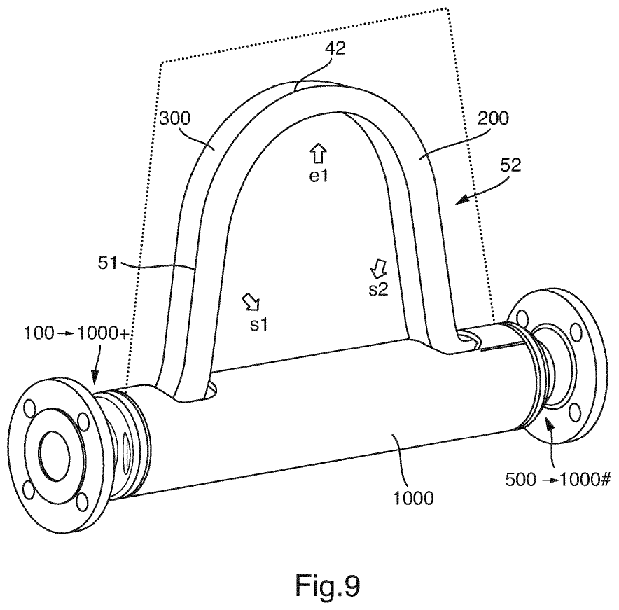

FIG. 9 schematically shows a side view of a measuring transducer formed by means of a fluid line system according to FIG. 6, 7, or 8 and used to measure at least one physical measurement variable of a fluid flowing in a pipeline. 13

In FIG. 1, 2, 3, 4, 5, 6, 7, 8, or 9, exemplary embodiments or details of a fluid line system used to guide a fluid, e.g., specifically a fluid measurement substance, are shown schematically.

The fluid line system can also be part of a measuring transducer, e.g., a vibronic measuring transducer, which is used for measuring at least one measurement variable of a fluid measurement substance guided in a pipeline, in particular a gas, a liquid, or a dispersion, e.g., according to one of the publications mentioned at the outset EP-A 816 807, US-A 2001/0037690, US-A 2008/0184816, US-A 2017/0219398, US-A 48 23 613, US-A 56 02 345, US-A 57 96 011, WO-A 90/15310, WO-A 00/08423, WO-A 2006/107297, WO-A 2006/118557, WO-A 2008/059262, WO-A 2008/013545, WO-A 2009/048457, WO-A 2009/078880, WO-A 2009/120223, WO-A 2009/123632, WO-A 2010/059157, WO-A 2013/006171, WO-A 2013/070191, WO-A 2015/162617, WO-A 2015/085025, or WO-A 2017/198440, or a measuring device formed by means of such a measuring transducer—for example, a Coriolis mass flow meter, a density meter, or a viscosity meter. Alternatively or in addition, the fluid line system can also be part of a transfer point for goods transport subject to calibration, such as a fuel dispensing system or a transfer point. The at least one measurement variable can therefore, for example, be a density or a viscosity of the fluid. The measurement variable can also, for example, be a temperature or a flow parameter of the fluid—for example, specifically a mass flow, a volume flow, or a flow velocity.

The fluid line system comprises a first (connecting) fitting 100, designed for example as a line branch or as a line union, with a lumen 100*, which is enclosed by a wall, extends from first and second, e.g., circular, flow openings, located in a first fitting end 100+ of the first (connecting) fitting 100 (spaced laterally from one another), as far as a third, in particular circular, flow opening, located in a second fitting end 100 #of said (connecting) fitting 100, e.g., enclosed by a connecting flange and remote from the fitting end 100+, as well as a first fluid line 200 connected to the (connecting) fitting 100 and a second fluid line 300 connected to the (connecting) fitting 100. The fluid line system can, for example, be integrated into the aforementioned pipeline in such a way that the (connecting) fitting 100 is arranged on the inlet side with respect to a flow direction of the fluid or the measurement substance allowed to flow through the fluid line system or a measuring transducer formed thereby and/or that the fluid or the measurement substance is allowed to flow in a predetermined flow direction through the pipeline and the fluid line system integrated into said pipeline.

The wall of the (connecting) fitting 100 has a front-side first (fitting) inner surface located in the region of its fitting end 100+ (facing the lumen of the fitting 100) and a lateral second (fitting) inner surface adjacent to the aforementioned first (fitting) inner surface and extending as far as the fitting end 100 #(facing the lumen of the fitting 100) or forms the aforementioned first and second (fitting) inner surfaces. The first and second flow openings of the fitting 100 are located within the first (fitting) inner surface. The first (fitting) inner surface can advantageously be at least partially, in particular predominantly or even completely, circular and/or at least partially, in particular predominantly or even completely, planar, and/or the second (fitting) inner surface can advantageously be at least partially, in particular predominantly or even completely, (circular-) cylindrical.

1 Each of the first and second fluid lines 200, 300 of the fluid line system, which are designed, for example, as a rigid and/or at least partially circular-cylindrical tube and/or are of identical construction, each has a lumen 200* or 300* which is surrounded by a wall and extends from a first, in particular circular, flow opening, located in a respective first line end 200+ or 300+ as far as a second, in particular circular, flow opening, located in a respective second line end 200 #or 300 #. As can also be seen from FIG. 2, the fluid line 200 is connected with its first line end 200+ to the first line end 100+ of the first (connecting) fitting 100 such that the first flow opening of said fluid line 200 opens into the first flow opening of the (connecting) fitting 100, and the fluid line 300 is connected with its first line end 300+ to the first line end 100+ of the (connecting) fitting 100 such that the first flow opening of the fluid line 300 opens into the second flow opening of the (connecting) fitting 100. Each of the fluid lines can also be curved, at least in sections, in particular V-shaped and/or U-shaped and/or circular-arc-shaped, and/or, as also indicated in FIG. 1 or 2, at least in sections straight, in particular hollow-cylindrical. Both the wall of the fitting and the wall of the first and second fluid lines can each be made of metal, e.g., at least partially, in particular completely, of a rust-free steel, such as a stainless steel, a duplex steel, or a super duplex steel. According to a further embodiment of the invention, it is further provided that one or more of the walls of the fluid lines and/or the wall of the fitting be made of AISI 304, AISI 304L, AISI 316L, WNo. 1.4401, WNo. 1.4404, UNS S31603, WNo. 1.4410, WNo. 14501, Hastelloy B, or Hastelloy C, e.g., Hastelloy C-22, or a nickel-molybdenum alloy—for example, a nickel-molybdenum-chromium alloy. Alternatively or additionally, the walls of the fluid lines 200, 300 can be made of the same material and/or the wall of the fitting 100 can be made of the same material as the wall of at least one of the fluid lines.

In order to adapt the fluid line system to the operating conditions, possibly only during installation in the aforementioned pipeline, or to (optimally) influence a flow profile of the fluid flowing through the fluid line system during operation, in particular in such a way that undesirable disturbances within the fluid flowing through the fluid line system are avoided as far as possible or at least kept to a minimum, the fluid line system according to the invention, as also shown schematically in FIG. 1, further comprises a (first)—for example monolithic and/or substantially cylindrical-flow-conditioner element 400 having fluidically parallel flow channels (401*, 402*) which is inserted into the lumen of the (connecting) fitting 100; this in particular in such a way that the flow-conditioner element 400 is inserted through the third flow opening of the (connecting) fitting 100 into the lumen of the first (connecting) fitting and/or that the flow-conditioner element 400 (in the final installation position) is locked on the (connecting) fitting 100 so as to be secured against rotation at least with respect to an (imaginary) longitudinal axis of the (connecting) fitting and/or at least immovable along the same longitudinal axis and/or is positioned with respect to the (connecting) fitting 100 substantially without a gap within its lumen. According to a further embodiment of the invention, the flow-conditioner element 400 is made of a material that is thermally and/or chemically compatible with the material of the wall of the (connecting) fitting 100 and/or with the fluid to be conducted in the fluid line system, in particular a metal, a plastic, or a ceramic, and/or the flow-conditioner element 400 is at least partially, e.g., predominantly or completely, manufactured by a primary forming process—for example, also by a solid free-form fabrication process, a powder bed process, or another generative or additive (3-D printing) manufacturing process. Alternatively or in addition, the flow-conditioner element 400, as also shown in FIG. 1 or 2 or also FIG. 3, can also be designed, for example, to be substantially sleeve-shaped or at least partially (circular-) cylindrical or, as also shown in FIG. 4, for example, substantially disk-shaped.

In the fluid line system according to the invention, the flow-conditioner element 400, as is also readily apparent from a consideration in combination of FIGS. 1 and 2, is inserted into the (connecting) fitting 100 in such a way that (in the final installation position) a first (flow-conditioner) element end 400+ faces the fitting end 100+ of the (connecting) fitting 100 or is proximal, and that a second (flow-conditioner) element end 400 #distal to or opposite the (flow-conditioner) element end 400+ faces away from the fitting end 100+ or faces the fitting end 100 #of the (connecting) fitting 100 or is proximal. Furthermore, the flow conditioner element 400 has a front-side, e.g., at least partially planar and/or circular, first (conditioner) outer surface forming the first (flow-conditioner) element end 400+ or (in the final installation position) facing the fitting end 100+ or the aforementioned first (fitting) inner surface, as well as a lateral, e.g., at least partially (circular-) cylindrical, second (conditioner) outer surface (lateral surface) adjoining or facing (in the final installation position) the aforementioned lateral second (fitting) inner surface. Furthermore, the flow-conditioner element 400 can have a substantially (circular-) ring-shaped, front-side third (conditioner) outer surface—for example, in a (narrow) region immediately adjacent to the second (conditioner) outer surface.

According to a further embodiment of the invention, the flow-conditioner element 400 is shaped such that its first (conditioner) outer surface is at least partially, e.g., 8 predominantly or completely, complementary to the aforementioned first (connector) inner surface and/or that its second (conditioner) outer surface is at least partially, e.g., predominantly or completely, complementary to the aforementioned second (connector) inner surface.

The flow-conditioner element 400 of the fluid line system according to the invention has, as already indicated, first and second, e.g., also non-circular-cylindrical and/or non-truncated-conical, flow channels (401*, 402*) which are connected fluidically in parallel, of which both the first flow channel 401* and the second flow channel 402* each extend from a respective first, e.g., circular, flow opening located in a region of the first (flow-conditioner) element end 400+, as far as a respective second, in particular non-circular, flow opening located in a region of the second (flow-conditioner) element end 400+. According to a further embodiment of the invention, the first flow openings of the first and second flow channels 401*, 402* are located within the aforementioned first (conditioner) outer surface, and/or the second flow openings of the first and second flow channels 401*, 402* are located within the aforementioned third (conditioner) outer surface.

According to a further embodiment of the invention, the second flow opening of the first flow channel (of the flow-conditioner element) has a (cross-sectional) shape that differs from a (cross-sectional) shape of the first flow opening of the first flow channel (of the flow-conditioner element), and/or the second flow opening of the second flow channel (of the flow-conditioner element) has a (cross-sectional) shape that differs from a (cross-sectional) shape of the first flow opening of the second flow channel (of the flow-conditioner element). Advantageously, the first flow opening of the first flow channel can have a (cross-sectional) shape corresponding to a (cross-sectional) shape of the first flow opening of the (connecting) fitting 100, and/or the first flow opening of the second flow channel can have a (cross-sectional) shape corresponding to a (cross-sectional) shape of the second flow opening of the (connecting) fitting 100; for example, also in such a way that the first flow opening of the first flow channel 401* and the first flow opening of the second flow channel 402* are the same size and/or that the first flow opening of the first flow channel 401* and the first flow opening of the (connecting) fitting 100 as well as the first flow opening of the second flow channel 402* and the second flow opening of the (connecting) fitting 100 are the same size. Alternatively or additionally, the first flow channel (of the flow-conditioner element) may have a shape which is identical to a shape of the second flow channel (of the flow-conditioner element).

In the fluid line system according to the invention, the flow-conditioner element 400 is also positioned and aligned in the (connecting) fitting 100 such that, as also shown in FIG. 1, a first flow path (of the fluid line system) extending partially through the (connecting) fitting 100 and involving the aforementioned first flow channel of the flow-conditioner element 400 and the lumen 200* of the fluid line 200, as well as a second flow path (of the fluid line system) also extending partially through the (connecting) fitting 100 and involving the aforementioned second flow channel of the flow-conditioner element 400 and the lumen 300* of the fluid line 300 are formed. Accordingly, the aforementioned third (conditioner) outer surface with the second flow openings of the first and second flow channels 401*, 402* located therein forms a (first) bifurcation (of the fluid line system) which connects the first and second flow paths within the (connecting) fitting 100. In order to prevent lateral displacement of the flow-conditioner element 400 in the installation position relative to the (connecting) fitting 100 as far as possible, the (connecting) fitting 100 and the flow-conditioner element 400 can advantageously also be designed such that at least the region of the lumen of the fitting 100 corresponding to the installation position of the flow-conditioner element 400 is substantially (circular-) cylindrical, and a corresponding inner diameter of the (connecting) fitting 100 at least in the same region substantially corresponds to a corresponding outer diameter of the equally (circular-) cylindrical flow-conditioner element 400—for example, is only larger by a slight amount that just allows the flow-conditioner element 400 to be inserted into the lumen of the (connecting) fitting 100. Alternatively or in addition, the wall of the (connecting) fitting 100 can also be designed such that it has a (smallest) inner diameter in a region adjacent to the fitting end 100 #which is—for example, by more than 1 mm-larger than a (largest) outer diameter of the flow-conditioner element 400—for example, in order to facilitate the insertion of the flow-conditioner element 400 into the fitting 100.

According to a further embodiment of the invention, the flow-conditioner element 400 is further shaped and positioned within the (connecting) fitting 100 such that its first (conditioner) outer surface at least partially, e.g., predominantly or substantially gap-free, contacts the aforementioned first (fitting) inner surface of the first (connecting) fitting and/or that its second (conditioner) outer surface at least partially, e.g., also predominantly or also substantially gap-free, contacts the aforementioned second (fitting) inner surface of the first (connecting) fitting—for example, in order to prevent fluid from penetrating into a region between the wall of the fitting 100 and the flow-conditioner element 400. Alternatively or in addition, the fluid line system, as also shown schematically in FIG. 5, can also comprise sealing means 800 positioned within the lumen (connecting) fitting 100, viz., at least partially between the second inner surface (of the wall of the first fitting) and the second outer surface (of the flow-conditioner element)—for example, formed by means of at least one annular sealing element. According to a further embodiment of the invention, the sealing means 800 comprise at least one O-ring placed on the flow-conditioner element 400 and/or a shaft sealing ring placed on the flow-conditioner element 400.

As already mentioned, the flow conditioning element 400 is connected to the fitting 100 or its wall firmly, but nevertheless non-detachably, in particular, specifically non-removably, or not without deformation or damage, possibly also not without destruction of the flow-conditioner element 400 itself, and/or not (re) detachably without deformation or damage, possibly also not without destruction of the (connecting) fitting 100—for example, viz., in an integrally bonded and/or form-fitting and/or frictionally engaged manner. The flow-conditioner element 400 and the (connecting) fitting 100 can be non-detachably connected to one another, for example, by the flow-conditioner element 400 being stretched into the (connecting) fitting 100 and/or by the flow-conditioner element 6 400 being soldered and/or welded into the (connecting) fitting 100, as also indicated in FIG. 5, and/or by the flow-conditioner element and the (connecting) fitting 100 being glued and/or pressed and/or caulked together, and/or by the (connecting) fitting 100 being shrunk onto the flow-conditioner element 400. In order to be able to easily ensure the correct alignment of the flow-conditioner element 400 in the installed position, not least with regard to an alignment of the first flow openings of its first and second flow channels with respect to the first and second flow openings of the (connecting) fitting 100, the flow-conditioner element 400 and the (connecting) fitting 100 can also be shaped such that the flow-conditioner element 400 and the (connecting) fitting 100 have outer and inner contours that complement each other, but prevent an incorrect installation position of the flow-conditioner element 400, e.g., such that the flow-conditioner element 400 has an (inner) contour, e.g., in the form of one or more grooves and/or one or more blind-holes, with one or more straight sections, and that the (connecting) fitting 100 has an (outer) contour, e.g., in the form of one or more grooves and/or, as also indicated in FIG. 5, one or more stud bolts having straight sections corresponding to the previously designated straight sections of the flow-conditioner element 400.

According to a further embodiment of the invention, the fluid line system further comprises, as also shown in FIGS. 6, 7, 8, and 9 respectively or readily apparent from their consideration in combination, a second (connecting) fitting 500 connected to the first and second fluid lines—correspondingly designed as a line branch or as a line union—with a lumen 500* surrounded by a wall and extending from first and second, e.g., circular, flow openings (spaced laterally from one another), located in a first fitting end 500+ of the (connecting) fitting 500 as far as a third, in particular circular, flow opening, located in a second fitting end 500 #of the same (connecting) fitting 500 which is remote from the fitting end 500+—for example, held by a connecting flange. The fitting 500, which is identical in construction to the (connecting) fitting 100, for example, is also connected to the first and second fluid lines in such a way that each of the two fluid lines 200, 300 is connected to the line end 500+ with its respective second line end (200 #, 300 #) and that the second flow opening of the fluid line 200 opens into the first flow opening (of the (connecting) fitting 500), and the second flow opening of the fluid line 300 opens into the second flow opening (of the fitting 500). A fluid line system thus formed can also be provided in particular to be integrated into a piping system, in such a way that the fitting end 100 #is fluidically connected to a pipe end, facing the fluid line system, of a first pipe segment of the piping system and/or that the fitting end 500 #is fluidically connected to a pipe end, facing the fluid line system, of a second pipe segment of the piping system, in particular to form a fluid duct that extends from the first pipe segment as far as the second pipe segment and/or is leakage-free.

The wall of the (connecting) fitting 500 has a front-side first (fitting) inner surface located in the region of its fitting end 500+ (facing the lumen of the fitting 500), within which the first and second flow openings of the fitting 500 are located, as well as a lateral second (fitting) inner surface adjacent to the aforementioned first (fitting) inner surface and extending as far as the fitting end 500 #(facing the lumen of the fitting 500). The first (fitting) inner surface can advantageously be at least partially, in particular predominantly or even completely, circular, and/or at least partially, in particular predominantly or even completely, planar, and/or the second (fitting) inner surface can advantageously be at least partially, in particular predominantly or even completely, (circular-) cylindrical.

In a corresponding manner, the fluid line system, as also shown schematically in FIG. 8, can also comprise a second flow-conditioner element 700 inserted into the fitting 500, e.g., also non-detachably connected thereto and/or monolithic and/or cylindrical and/or metallic, of which a first (flow-conditioner) element end 700+ faces the fitting end 500+, and a second (flow-conditioner) element end 700 #remote therefrom faces the fitting end 500 #. The flow-conditioner element 700 likewise has first and second, e.g., non-circular-cylindrical and/or non-truncated-cone-shaped, flow channels (701*, 702*) which are connected fluidically in parallel, of which both the first flow channel 701* and the second flow channel 702* each extend from a respective first, in particular circular, flow opening located in the (flow-conditioner) element end 700+, as far as a respective second, in particular non-circular, flow opening located in the (flow-conditioner) element end 700 #. The flow-conditioner element 700 is also positioned and aligned in the (connecting) fitting 500 such that the aforementioned first flow path (of the fluid line system) involves the flow channel 701*, and the aforementioned second flow path (of the fluid line system) involves the flow channel 702*. According to a further embodiment of the invention, the flow-conditioner element 700 is designed and arranged in the fitting 500 in such a way that an, in particular, at least partially planar and/or at least partially circular, front-side first outer surface of the flow-conditioner element 700 forms its element end 700+ or faces the nozzle end 500+—for example, viz., contacts the aforementioned first (fitting) inner surface of the wall of the (connecting) fitting 500 and/or is at least partially complementary to said first (fitting) inner surface. In addition, the flow-conditioner element 700 is designed and arranged in the fitting 500 such that a lateral second outer surface (shell surface) of the flow-conditioner element 700, which surface is at least partially complementary to the aforementioned second (fitting) inner surface of the wall of the (connecting) fitting 500, e.g., at least partially (circular-) cylindrical, faces the second (fitting) inner surface, in particular contacts the second (fitting) inner surface, and that a front-side third outer surface, e.g., at least partially curved and/or (circular-) annular in a region, adjacent to the wall, of the second (connecting) fitting, of the flow-conditioner element 700 faces the fitting end 700 #. In addition, the first flow openings of the first and second flow channels 701*, 702* of the flow-conditioner element 700 are located within the aforementioned first (conditioner) outer surface, and/or the second flow openings of the first and second flow channels 701*, 702* are located within the aforementioned third (conditioner) outer surface. The flow-conditioner element 700 can, for example, be constructed identically to the flow-conditioner element 400 used in the fitting 100. Alternatively, however, the flow-conditioner element 700 can also have a design that deviates from a design of the flow-conditioner element 400 inserted in the fitting 100—for example, such that at least the third outer surface of the flow-conditioner element 700 has a (spatial) form that deviates from a (spatial) form of the third outer surface of the flow-conditioner element 400.

Not least for the aforementioned case where the fluid line system is part of a vibronic measuring transducer or a vibronic measuring device formed therewith, according to a further embodiment of the invention, at least the fluid line 200 is also designed to have fluid flow through it and to be allowed to vibrate during this process. Furthermore, the fluid line 300 can also be designed to have fluid flow through it and to be allowed to vibrate during this process; for example, this can also be done in such a way that the two fluid lines 200, 300 have fluid flowing through them simultaneously and/or are allowed to vibrate simultaneously, in particular in opposite directions. Accordingly, according to a further embodiment of the invention, the fluid line system further comprises a sensor arrangement which is designed to provide at least one, e.g., electrical and/or analog, measurement signal s1 representing the at least one measurement variable; this in particular in such a way that the measurement signal s1 has at least one signal parameter which is dependent upon the measurement variable, viz., follows changes in the measurement variable with a corresponding change. A signal parameter dependent upon the measurement variable can, for example, be a signal level dependent upon the at least one measurement variable, a signal frequency dependent upon the same measurement variable, and/or a phase angle of the measured signal dependent upon the same measurement variable. As indicated in FIG. 9, the sensor arrangement can be placed outside the fluid lines 300, 200, but also in the vicinity thereof—for example, in such a way that the sensor arrangement is attached to at least one of the fluid lines 300, 200. According to a further embodiment of the invention, the sensor arrangement is further configured to detect mechanical vibrations of at least one of the two aforementioned fluid lines 300, 200, e.g., bending vibrations of the fluid line 300 and/or the fluid line 200 at one or more resonance frequencies inherent in the fluid line system, and to provide at least one vibration signal representing vibrations of at least one of the fluid lines or serving as a measurement signal. For this purpose, the sensor arrangement can, for example, have an electrodynamic and/or vibration sensor 51 that differentially detects vibration movements of the two fluid lines 300, 200. According to a further embodiment of the invention, the fluid line system or the measuring transducer formed therewith also has an electro-mechanical excitation arrangement which is designed to convert electrical power into mechanical power causing mechanical vibrations of the fluid lines—for example, viz., the aforementioned bending vibrations of the fluid line 300 and/or the fluid line 200. Said excitation arrangement can be formed, for example, by means of at least one vibration exciter 41 acting electrodynamically and/or differentially on the two fluid lines 300, 200. Not least for the aforementioned case where the fluid line system is intended to measure a mass flow based upon Coriolis forces generated in the flowing fluid, the sensor arrangement or the fluid line system formed therewith, as also indicated in FIG. 9, in addition to the vibration sensor 51, also have at least one second vibration sensor 52 for generating at least one second, in particular electrical and/or analog, vibration measurement signal, corresponding to the measurement variable, serving as a second measurement signal s2. Said vibration sensor 52 can be identical in construction to the vibration sensor 51 and/or positioned at the same distance as the vibration sensor 51 from the fluid line 300 or the fluid lines 300, 200. Alternatively or additionally, the vibration sensors 51, 52 can be positioned symmetrically with respect to the aforementioned vibration exciter 41.

For the purpose of processing or evaluating the at least one measurement signal s1 or the measurement signals s1, s2, a measuring device formed by means of the aforementioned fluid line system can further comprise measuring and operating electronics which are electrically coupled to the sensor arrangement and for example formed by means of at least one microprocessor and/or a digital signal processor (DSP), which electronics in turn can advantageously be accommodated in a protective housing which is sufficiently dust—and water-tight or impact—and explosion-proof. In particular, such measuring and operating electronics can further be set up to process the at least one measuring signal s1 or the measuring signals s1, s2—for example, to determine measured values for the at least one measurement variable by means of the measuring signal s1 and/or the measuring signal s2. In the aforementioned case where the fluid line system is equipped with at least one vibration exciter 41, the measuring and operating electronics can also be electrically coupled to the aforementioned vibration exciter 41 and can also be set up to feed an electrical excitation signal e1 into the aforementioned vibration exciter 41, and the vibration exciter 41 can also be set up to convert electrical power fed in by means of the excitation signal e1 into mechanical (useful) vibrations of at least the fluid line 200 or into mechanical power causing mechanical (useful) vibrations of both the fluid line 300 and the fluid line 200.

As shown schematically in FIG. 9, the fluid line system can further comprise a protective housing 1000 for the fluid lines 300, 200, not least when used in a measuring transducer or measuring device. The protective housing 1000 has a cavity which is enclosed by a wall and within which the fluid line 200 and at least the fluid line 300 are placed. Not least for the purpose of forming a sufficiently torsion—and bending-resistant or impact-proof and pressure-resistant protective housing, its wall can, for example, be made of a metal, such as stainless steel, and/or, as is quite common and indicated in FIG. 9, be at least partially hollow-cylindrical. As further indicated in FIG. 9, a first housing end 1000+ of the protective housing 1000 can also be formed by means of the (connecting) fitting 100, e.g., in such a way that the (connecting) fitting 100 is an integral part of the protective housing and/or that the protective housing 1000 has a side wall which laterally delimits the aforementioned cavity and which is laterally fixed to the (connecting) fitting 100 or is connected to it in an integrally bonded manner. In addition, a second housing end 1000 #of the same protective housing 1000 can also be formed by means of the aforementioned second (connecting) fitting 500, e.g., in such a way that both the first (connecting) fitting 100 and the second (connecting) fitting are each an integral part of the protective housing or that the protective housing 1000 has a side wall which laterally delimits the cavity and is laterally fixed to both the first (connecting) fitting 100, in particular its first fitting end 100+, and the second (connecting) fitting, in particular its first fitting end, or is connected thereto in an integrally bonded manner.

1-34. (canceled)

35. A fluid line system for a measuring transducer configured to measure at least one measurement variable of a medium, which is guided in a pipeline, or for a measuring device formed therewith, the fluid line system comprising:
a first connecting fitting configured as a line branch or a line union and including a first fitting lumen defined by a wall and extending from a circular first flow opening to a circular second flow opening, which first and second flow openings of the first connecting fitting are spaced apart from each other and are disposed in a first fitting end of the first connecting fitting, wherein the first fitting lumen extends to a third flow opening disposed in a second fitting end of the first connecting fitting, which second fitting end is enclosed by a connecting flange and remote from the first fitting end;
a first fluid line, which is a rigid and/or at least partially circular-cylindrical tube, including a first line lumen defined by a wall and extending from a circular first flow opening, disposed in a first line end of the first fluid line, to a circular second flow opening, disposed in a second line end of the first fluid line;
at least one second fluid line, which is a rigid and/or at least partially circular-cylindrical tube and/or structurally identical to the first fluid line, including a second line lumen defined by a wall and extending from a circular first flow opening, disposed in a first line end of the second fluid line, to a circular second flow opening, disposed in a second line end of said second fluid line; and
a first flow-conditioner element, which is introduced into the first fitting lumen and is non-detachably connected thereto and/or without a gap thereto, and which is monolithic and/or cylindrical and/or metallic, wherein the first flow-conditioner element includes a first flow channel and a second flow channel, which are each non-circular-cylindrical and/or non-truncated-cone-shaped and which are connected fluidically in parallel, of which first flow-conditioner element:
a first element end faces or is adjacent the first fitting end of the first connecting fitting; and
a second element end, remote from the first element end, faces the second fitting end of the first connecting fitting,
wherein the first fluid line is connected at its first line end to the first line end of the first connecting fitting such that the first flow opening of the first fluid line opens into the first flow opening of the first connecting fitting,
wherein the second fluid line is connected at its first line end to the first line end of the first connecting fitting such that the first flow opening of the second fluid line opens into the second flow opening of the first connecting fitting,
wherein each of the first and second flow channels of the first flow-conditioner element extends from a respective first flow opening, disposed in a region of the first element end, to a respective, non-circular second flow opening, disposed in a region of the second element end; and
wherein the first flow-conditioner element is arranged and aligned in the first connecting fitting so as to form a first flow path of the fluid line system, including the first flow channel of the first flow-conditioner element and the first line lumen, and a second flow path of the fluid line system, including the second flow channel of the first flow-conditioner element and the second line lumen.

36. The fluid line system according to claim 35, wherein at least one of:
the first flow opening of the first flow channel is circular;
the second flow opening of the first flow channel has a cross-sectional shape that differs from a cross-sectional shape of the first flow opening of the first flow channel;
the second flow opening of the first flow channel is not circular and is specifically circular-segment-shaped;
the first flow opening of the first flow channel has a cross-sectional shape corresponding to a cross-sectional shape of the first flow opening of the first connecting fitting;
the first flow opening of the second flow channel is circular;
the second flow opening of the second flow channel has a cross-sectional shape that differs from a cross-sectional shape of the first flow opening of the second flow channel;
the second flow opening of the second flow channel is not circular and is specifically circular-segment-shaped;
the first flow opening of the second flow channel has a cross-sectional shape corresponding to a cross-sectional shape of the second flow opening of the first connecting fitting; and
the first flow channel has a shape identical to a shape of the second flow channel.

37. The fluid line system according to claim 35, wherein the wall of the first connecting fitting defines or includes:
a front-side first inner surface, which is at least partially planar and/or circular and which is disposed in a region of the first fitting end of the first connecting fitting, facing the first fitting lumen; and
a lateral second inner surface facing the first fitting lumen, which second inner surface is at least partially circular-cylindrical, extends from the first fitting end to the second fitting end, and borders on the first inner surface.

38. The fluid line system according to claim 37, wherein the first and second flow openings of the first connecting fitting are disposed within the first inner surface of the wall of the first connecting fitting.

39. The fluid line system according to claim 37, wherein the first flow-conditioner element includes:
a front-side first outer surface, which forms the first element end or faces the first fitting end, is at least partially planar and/or circular, and/or contacts the first inner surface of the first connecting fitting and/or is at least partially complementary to the first inner surface of the first connecting fitting; and
a lateral second outer surface, which faces the lateral second inner surface of the wall of the first connecting fitting, contacts the second inner surface of the first connecting fitting, and/or is at least partially complementary to the second inner surface of the first connecting fitting and/or is at least partially circular-cylindrical.

40. The fluid line system according to claim 39, wherein the first flow-conditioner element includes a front-side third outer surface, which faces the second fitting end of the first connecting fitting and is at least partially curved and/or ring-shaped in a region adjacent the wall of the first connecting fitting.

41. The fluid line system according to claim 40, wherein the third outer surface defines a bifurcation of the fluid line system connecting the first and second flow paths.

42. The fluid line system according to claim 35, wherein the first flow-conditioner element is disc-shaped.

43. The fluid line system according to claim 35, wherein the first flow-conditioner element is at least partially circular-cylindrical.

44. The fluid line system according to claim 35, wherein the first flow-conditioner element comprises a metal.

45. The fluid line system according to claim 35, wherein the first flow-conditioner element comprises a plastic.

46. The fluid line system according to claim 35, wherein the first flow-conditioner element comprises a ceramic.

47. The fluid line system according to claim 35, wherein the first flow-conditioner element is at least partially fabricated by a generative or additive primary forming process, including a solid free-form fabrication and/or a powder bed process.

48. The fluid line system according to claim 35, wherein the wall of the first connecting fitting comprises a rust-free steel, including a stainless steel, a duplex steel, or a super duplex steel.

49. The fluid line system according to claim 35, wherein at least one of:
the wall of the first connecting fitting is made of a nickel-molybdenum alloy, a nickel-molybdenum-chromium alloy, AISI 304, AISI 304L, AISI 316L, WNo. 1.4401, WNo. 1.4404, UNS S31603, WNo. 1.4410, WNo. 14501, Hastelloy B, Hastelloy C, or Hastelloy C-22;
the wall of the first fluid line is made of a nickel-molybdenum alloy, a nickel-molybdenum-chromium alloy, AISI 304, AISI 304L, AISI 316L, WNo. 1.4401, WNo. 1.4404, UNS S31603, WNo. 1.4410, WNo. 14501, Hastelloy B, or Hastelloy C, in particular Hastelloy C-22; and
the wall of the second fluid line is made of a nickel-molybdenum alloy, a nickel-molybdenum-chromium alloy, AISI 304, AISI 304L, AISI 316L, WNo. 1.4401, WNo. 1.4404, UNS S31603, WNo. 1.4410, WNo. 14501, Hastelloy B, Hastelloy C, or Hastelloy C-22.

50. The fluid line system according to claim 35, wherein at least one of:
the wall of the first fluid line consists of the same material as the wall of the second fluid line;
the wall of the first fluid line consists of the same material as the wall of the first connecting fitting; and
the wall of the second fluid line consists of the same material as the wall of the first connecting fitting.

51. The fluid line system according to claim 35, wherein the first flow-conditioner element is non-detachably connected to the first connecting fitting by being welded and/or soldered and/or expanded into the first connecting fitting.

52. The fluid line system according to claim 35, wherein the first flow-conditioner element is non-detachably connected to the first connecting fitting by gluing and/or pressing and/or caulking the first flow-conditioner element and the first connecting fitting together.

53. The fluid line system according to claim 35, wherein the first flow-conditioner element is non-detachably connected to the first connecting fitting by shrinking the first connecting fitting onto the first flow-conditioner element.

54. The fluid line system according to claim 35, wherein the first fluid line, at least in sections, is curved, V-shaped, U-shaped and/or circular-arc-shaped; and/or
wherein the first fluid line is straight, at least in sections.

55. The fluid line system according to claim 35, further comprising:
a second connecting fitting configured as a line branch or a line union and/or of identical construction to the first connecting fitting, and including a second fitting lumen defined by a wall and extending from circular first and second flow openings, which first and second flow openings of the second connecting fitting are spaced apart from each other and are disposed in a first fitting end of the second connecting fitting, to a third flow opening, which is circular and disposed in a second fitting end of the second connecting fitting, which second fitting end is enclosed by a connecting flange and remote from the first fitting end,
wherein the first fluid line is connected by its second line end to the first line end of the second connecting fitting such that the second flow opening of the first fluid line opens into the first flow opening of the second connecting fitting; and
wherein the second fluid line is connected by its second line end to the first line end of the second connecting fitting such that the second flow opening of the second fluid line opens into the second flow opening of the second connecting fitting disposed in the first fitting end of the second connecting fitting.

56. The fluid line system according to claim 55, further comprising:
a second flow-conditioner element, which is introduced into the second fitting lumen through the third flow opening of the second connecting fitting and is non-detachably connected and/or without a gap to the second connecting fitting, which is monolithic and/or cylindrical and/or metallic, wherein the second flow-conditioner element includes first and second flow channels, which are each non-circular-cylindrical and/or non-truncated-cone-shaped, and which are connected fluidically in parallel, of which second flow-conditioner element:
a first element end faces the first fitting end of the second connecting fitting; and
a second element end, remote from the first element end, faces the second fitting end of the second connecting fitting;
wherein each of the first and second flow channels of the second flow-conditioner element extends from a respective first flow opening, disposed in the first element end, to a respective non-circular second flow opening, disposed in the second element end; and
wherein the second flow-conditioner element is arranged and aligned in the second connecting fitting such that:
the first flow path of the fluid line system includes the first flow channel of the second flow-conditioner element; and
the second flow path of the fluid line system includes the second flow channel of the second flow-conditioner element.

57. The fluid line system according to claim 56, wherein the wall of the second connecting fitting defines or includes:
a first fitting inner surface, which is at least partially planar and/or circular and which is disposed in a region of the first fitting end of the second connecting fitting; and
a second inner surface facing the second fitting lumen, which second inner surface is at least partially circular-cylindrical, extends from the first fitting end to the second fitting end adjacent the first inner surface such that the first and second flow openings of the second connecting fitting are disposed within the first connector inner surface of the wall of the second connecting fitting.

58. The fluid line system according to claim 57, wherein the second flow-conditioner element includes:
a front-side first outer surface, which defines the first element end or faces the first fitting end of the second connecting fitting and which is at least partially planar and/or circular and/or contacts the first inner surface of the second connecting fitting and/or is at least partially complementary to the first inner surface of the second connecting fitting;
a lateral second outer surface, which faces the lateral second inner surface of the wall of the second connecting fitting and which contacts the second inner surface of the second connecting fitting and/or is at least partially complementary to the second inner surface of the second connecting fitting and/or is at least partially circular-cylindrical; and
a front-side third outer surface, which faces the second fitting end of the second connecting fitting and which is at least partially curved and/or ring-shaped in a region adjacent the wall of the second connecting fitting.

59. The fluid line system according to claim 58, wherein the first flow-conditioner element includes a front-side third outer surface, which faces the second fitting end of the first connecting fitting and is at least partially curved and/or ring-shaped in a region adjacent the wall of the first connecting fitting, and
wherein the second flow-conditioner element configured differently than a configuration of the first flow-conditioner element such that at least the third outer surface of the second flow-conditioner element has a spatial form that deviates from a spatial form of the third outer surface of the first flow-conditioner element.

60. The fluid line system according to claim 55, wherein the measuring transducer is configured to be integrated into a piping system such that the second fitting end of the first connecting fitting is connected to a pipe end, facing the fluid line system, of a first pipe segment of the piping system and/or that the second fitting end of the second connecting fitting is fluidically connected to a pipe end, facing the fluid line system, of a second pipe segment of the piping system, so as to form a fluid duct that extends from the first pipe segment to the second pipe segment and/or is leakage-free.

61. A vibronic measuring transducer for detecting at least one measurement variable of a flowing medium and for generating at least one measuring signal corresponding to the at least one measurement variable, which measuring transducer comprises the fluid line system according to claim 35.

62. The measuring transducer according to claim 61, further comprising:
a transducer protective housing, wherein the protective housing comprises a cavity which is enclosed by a wall and is made of a metal, and within which the first and second fluid lines are disposed; and
wherein a first housing end of the protective housing is formed by the first connecting fitting, and a second housing end of the protective housing is formed by the second connecting fitting, such that the protective housing includes a side wall laterally delimiting the cavity, at least in part, which is connected in a fixed manner or in an integrally bonded manner laterally both at the first connecting fitting, to the first fitting end thereof, and at the second connecting fitting, to the first fitting end thereof.

63. The measuring transducer according to claim 62, wherein the first and second fluid lines are configured to enable the first and second fluid lines to vibrate as the medium flows therethrough.

64. The measuring transducer according to claim 63, further comprising an electro-mechanical excitation arrangement configured to convert electrical power into mechanical power so as to cause mechanical vibrations of the first and second fluid lines.

65. The measuring transducer according to claim 64, further comprising a sensor arrangement configured to detect mechanical vibrations of the first and second fluid lines and to generate at least one vibration signal representing the mechanical vibrations of at least one of the first and second fluid lines.

66. A measuring device, comprising:
a measuring transducer according to claim 65; and
measuring device electronics, which are electrically connected to the measuring transducer and configured to process the at least one vibration signal.

67. The measuring device according to claim 66, wherein the measuring device electronics are configured to supply an electrical driver signal into the measuring transducer.

68. The measuring device according to claim 66, wherein the measuring device electronics are electrically coupled to the excitation arrangement so as to supply electrical power to the excitation arrangement via the electrical driver signal; and/or
wherein the excitation arrangement is configured to convert electrical power fed by the measuring device electronics via the electrical driver signal into mechanical power causing mechanical vibrations of at least the first fluid line.

69. Measuring device according to claim 66, wherein the measuring device electronics are electrically coupled to the sensor arrangement and are configured to process the at least one vibration signal so as to determine measured values for the at least one measurement variable by the at least one vibration signal.

70. A method for determining measured values of at least one measurement variable of a fluid measurement substance conducted in a pipe, wherein the measurement substance is a gas, a liquid, or a dispersion, the method comprising:
determining measured values for the at least one measurement variable using the measuring device of claim 66,
wherein the at least one measurement variable is at least one of: a mass flow rate, a mass flow, a volumetric flow rate, a volumetric flow, a density, a viscosity, or a temperature of the fluid measurement substance,
wherein the first connecting fitting is arranged on the inlet side with respect to a flow direction of the measurement substance flowing through the measuring transducer, and/or
wherein the measuring transducer is incorporated into the pipe.
